(19) United States
(12) Patent Application Publication
(10) Pub. No.: US 2007/0231046 A1
(43) Pub. Date: Oct. 4, 2007

(54) Cleaning device having heated cleaning solution

(75) Inventors: Bryan S. Whiffen, Anderson, SC (US); John W. Schnell, Anderson, SC (US); Carlton R. Lay, Greenville, SC (US)

Correspondence Address: BRINKS HOFER GILSON & LIONE, P.O. BOX 10395, CHICAGO, IL, 60610, US

(73) Assignee: Eastway Fair Company Limited

(21) Appl. No.: 11/714,658

(22) Filed: Mar. 6, 2007

Related U.S. Application Data
(60) Provisional application No. 60/782,584, filed on Mar. 14, 2006.

(51) Int. Cl. B08B 3/00; B43M 1/02; A47L 13/30

(52) U.S. Cl. 401/1; 134/105; 134/198; 134/34; 401/139

(57) ABSTRACT

A cleaning device having a cleaning solution that can be heated is disclosed. The cleaning device has a fluid reservoir connected to a handle wherein the fluid reservoir contains a volume of cleaning fluid. The device also contains a heating unit disposed within the cavity in the fluid reservoir and has a first reactant chamber with a first reactant and a second reactant chamber with a second reactant. When the reactants are mixed, heat is generated to heat the cleaning fluid.

Applicants claim priority to U.S. Provisional Patent Application Ser. No. 60/782,584, filed on Mar. 14, 2006, the entire contents of which are incorporated herein by reference.

### BACKGROUND

The present application relates to cleaning devices having self-heating cleaning solution reservoirs. In one embodiment, the invention relates to a mop having a cleaning solution reservoir and a self-contained heater configured to heat the contents of to the reservoir.

Conventional straight handled cleaning implements, such as mops, are known in the prior art and typically comprise a handle attached to a substantially flat cleaning head member. These devices are generally controlled by applying a force to the handle that results in the cleaning head member moving in the direction of the force. In addition, cleaning implements are known which include a liquid delivery system having a cleaning fluid reservoir and a sprayer nozzle. In some mop cleaning implements, the cleaning fluid reservoir is attached to the handle of the mop and cleaning fluid is dispensed through a sprayer nozzle in the vicinity of the cleaning head member.

While these cleaning implements provide some cleaning benefits, they use cleaning fluid that is at room temperature. It has been observed, however, that room temperature cleaning fluid may not provide the optimum cleaning performance.

Other cleaning implements such as motorized steam vacuum cleaners, or wet vacuum cleaners, provide heated liquid, but can be heavy and bulky, which results in the implements being difficult to manipulate. Additionally, motorized steam vacuum cleaners require access to electrical outlets. This can reduce the mobility and range of the implement.

### BRIEF SUMMARY

In one aspect of the present invention a cleaning device is provided. The device has a handle having a first end and a second end, with a grip section proximal to the first end. The device also has a cleaning surface section proximal to the second end and engageable with a surface to be cleaned. The device also has a fluid delivery nozzle connected to the cleaning surface section for distributing cleaning solution to the surface to be cleaned. The device also has a fluid reservoir connectable to the handle and defining a cavity in fluid communication with the fluid delivery nozzle. The device further has a heating unit configured to increase the temperature of the cleaning fluid.

In another aspect of the present invention a motorless cleaning device is provided. The cleaning device includes a handle having a first end and a second end and a cleaning surface section proximal to the second end and engageable with a surface to be cleaned. The cleaning device also includes a cleaning fluid container connectable to the handle and defining a chamber for holding a volume of cleaning fluid. The cleaning device further includes a fluid delivery nozzle in fluid communication with the cleaning fluid container for distributing cleaning fluid to the surface to be cleaned. The cleaning device also includes a heating unit in thermal contact with the cleaning fluid container and operable to increase the temperature of the cleaning fluid within the cleaning fluid container.

In yet another aspect of the present invention, a method of cleaning a surface using heated cleaning fluid is provided. One step of the method includes providing a motorless heated cleaning fluid assembly comprising a cleaning fluid container for holding a volume of cleaning fluid, a heating unit in thermal contact with the cleaning fluid container, and a cleaning surface section connected with the cleaning fluid container. Another step of the method of cleaning a surface includes activating the heating unit to generate heat. Yet another step of the method of cleaning a surface includes warming the cleaning fluid within the cleaning fluid container with heat generated by the heating unit. And yet another step of the method of cleaning a surface includes applying the warmed cleaning fluid to the surface to be cleaned such that the surface to be cleaned is wetted with cleaning fluid.

In another aspect of the present invention a cleaning fluid heating system is provided. The system includes a cleaning fluid reservoir for containing a volume of cleaning fluid and a self contained heating unit in thermal contact with the cleaning fluid reservoir. Heat generated by the self-contained heating unit warms the volume of cleaning fluid within the cleaning fluid reservoir.

Advantages of the present invention will become more apparent to those skilled in the art from the following description of the preferred embodiments of the invention which have been shown and described by way of illustration. As will be realized, the invention is capable of other and different embodiments, and its details are capable of modification in various respects. Accordingly, the drawings and description are to be regarded as illustrative in nature and not as restrictive.

### BRIEF DESCRIPTION OF THE DRAWINGS

FIG. 1 is a perspective view of a cleaning implement according to one embodiment of the present invention;

FIG. 2a is a partial exploded view of a cleaning fluid container according to one embodiment of the present invention;

FIG. 2b is another partial exploded view of a cleaning fluid container according to the embodiment of the present invention depicted in FIG. 2a; and

FIG. 3 is a perspective view of a cleaning fluid container according to one embodiment of the present invention with a portion cut-away to show internal features;

FIG. 4 is a cross section view of a self-contained heating unit according one embodiment of the present invention.

FIG. 5 is a cross section view of a self-contained heating unit according another embodiment of the present invention.

### DETAILED DESCRIPTION

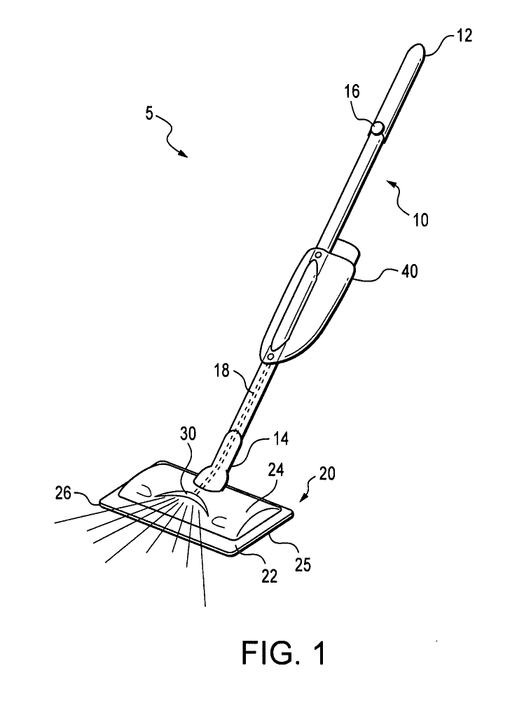

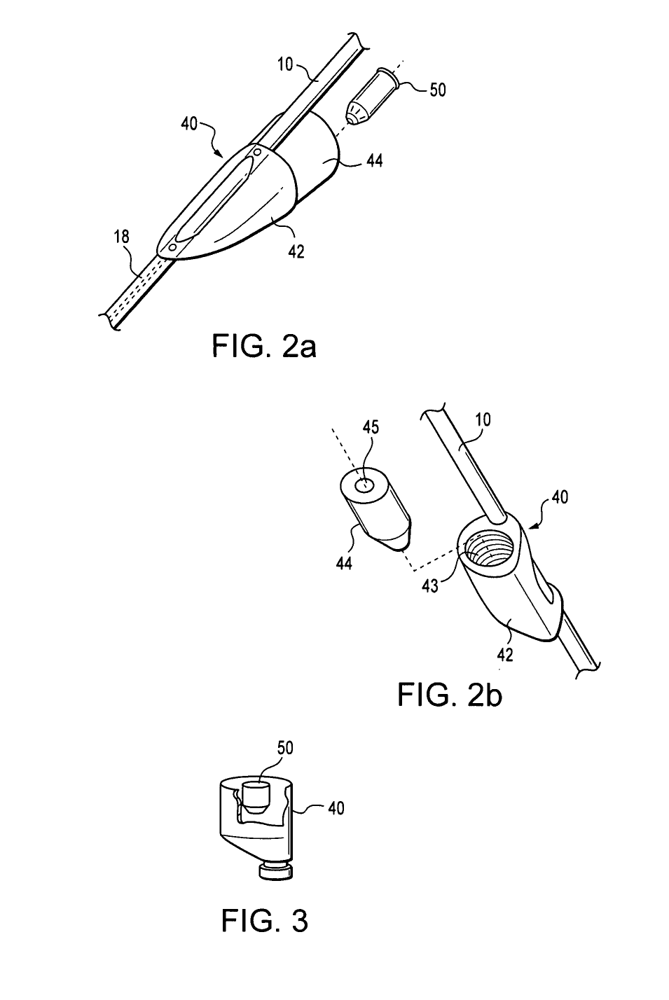

FIG. 1 illustrates a self-heating cleaning implement 5 according to principles of the present invention. In one embodiment of the present invention, the cleaning implement 5 comprises a handle 10, a cleaning surface section 20, a fluid delivery section 30, and a cleaning fluid container 40. Details on the various components are provided below. In general terms, however, the cleaning implement 5 is used to clean a surface or fabric. The cleaning surface section 20 contacts the surface or fabric to be cleaned. Cleaning fluid in the cleaning fluid container 40 is heated by a self contained heating unit 50 (depicted in FIGS. 2a and 3) to a predetermined temperature. Cleaning fluid is then transported from the cleaning fluid container 40 to the fluid delivery section 30. The fluid delivery section 30 is then operative to dispense heated cleaning fluid in the vicinity of the cleaning surface section 20.

With reference to FIG. 1, a cleaning implement 5 according to one embodiment is disclosed. While the cleaning implement shown and described in FIG. 1 is in the form of a mop, one skilled in the art will understand that the present invention may be useful with a variety of cleaning implements. For ease of discussion, however, the present invention will be described in connection with the mop shown in FIG. 1. In this embodiment, the cleaning implement 5 may contain an elongated handle 10 having a grip section 12 proximal to a user and a cleaning head section 14 distal from the user. The grip section 12 is operative to engage a user's hand and allow convenient and ergonomic manipulation of the cleaning implement 5. The cleaning head section 14 acts as an interface between the handle 10 and the cleaning surface section 20. The cleaning head section 14 may comprise a joint to allow multi-axis pivoting of the handle 10 with respect to the cleaning surface section 20. One skilled in the art will understand that pivotal attachment may be accomplished in a variety of ways. In one aspect, the cleaning head section 14 pivotally attaches the cleaning surface section 20 to the handle 10 by a universal joint.

The handle 10 desirably includes a fluid line 18 that defines a fluid connection from the cleaning fluid container 40 to the fluid delivery section 30. The handle 10 may include a trigger 16 on the exterior of the handle operative to create pressure within the fluid line 18 to force cleaning fluid from the cleaning fluid container 40 to the fluid delivery section 30.

The cleaning surface section 20 is shown as having a generally rectangular shape. The cleaning surface section 20 may have any suitable shape such as square, triangular, circular or oval, or any other shape suitable for cleaning a variety of objects. The cleaning surface section includes an upper surface 24 and a substantially flat lower surface 25. The lower surface 25 interfaces with the surface or fabric being cleaned. A bumper may surround the outer periphery of the cleaning surface section 20 to define the substantially flat lower surface 25. The bumper may be formed of any suitable material to provide protection to articles being cleaned resulting from contact with the cleaning surface section 20. The cleaning surface section 20 may include a cleaning fabric 22 removably attached to a portion of the lower surface 25. The cleaning fabric 22 may be removably attached using hook fasteners that are molded onto the upper surface 24 of the cleaning surface section 20. Other fastening methods are known to one skilled in the art.

The fluid delivery section 30 is attached to the upper surface 24 of the cleaning surface section 20, adjacent to a leading edge 26 of the cleaning surface section 20. In this way, the fluid delivery section 30 moves in the same direction as the cleaning surface section 20. The fluid delivery section 30 may include a sprayer nozzle for separating the cleaning fluid into a predetermined particle size and for delivering the fluid in a predetermined fan shape and angle.

With reference to FIGS. 2a and 2b, a cleaning fluid container 40 according to one embodiment is disclosed. The cleaning fluid container 40 includes a holder 42 and a fluid reservoir 44 containing a volume of cleaning fluid. In one embodiment, the holder 42 is operative to connect the cleaning fluid container 40 to the handle 10. The holder 42 may include a cavity 43 operative to removably engage the fluid reservoir 44. According to another embodiment, the holder 42 and fluid reservoir 44 are integral with each other. In yet another embodiment, the holder 42 and fluid reservoir 44 are formed monolithically.

The fluid reservoir 44 may contain a second cavity 45 operative to engage a self-contained heating unit 50. The self-contained heating unit 50 is in thermal contact with the cleaning fluid reservoir 44. The self-contained heating unit 50 generates heat and warms the cleaning fluid in the fluid reservoir 44. In the embodiment depicted in FIGS. 2a and 2b, the heating unit 50 is removable from the fluid reservoir 44. In this embodiment, the heating unit 50 and fluid reservoir 44 may be purchased and stored separately until use. Additionally, a first heating unit 50 may be replaced with a second heating unit after the first heating unit 50 has cooled. In this embodiment, it will be appreciated that a fluid reservoir 44 may be heated by multiple consecutive heating units 50 when a cleaning job is particularly long or when there is a time lapse between cleaning jobs before the fluid reservoir 44 is depleted.

With reference to FIG. 3, another embodiment of the fluid container 40 is provided wherein the fluid reservoir 44 and heating unit 50 are provided as a single-use unit. In this embodiment, the fluid reservoir 44 and heating unit 50 may be purchased and stored as one unit. During use, the single-use unit is attached to the handle 10 and the heating unit 50 is activated. The single-use unit may then be removed and discarded after the liquid reservoir 44 is depleted or the heating unit 50 has cooled. According to one embodiment, the fluid container 40 may connect to the handle via a snap fit one-way valve 51. Of course, the fluid container 40 may be connected in other well known means.

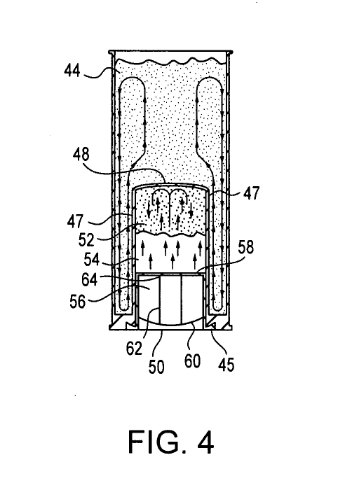

FIG. 4 discloses one embodiment of the self-contained heating unit 50 disposed within a cavity 45 of the fluid reservoir 44. FIG. 4 shows a cross-section of the fluid reservoir 44 and the heating unit 50 in the assembled state with the heating unit 50 having been inserted into the cavity 45. FIG. 4 illustrates the cavity 45 of the fluid reservoir 44 defined by sidewalls 47 and top wall 48. While not explicitly shown, the interior wall of cavity 45 may be fluted to provide more surface area to facilitate heat transfer from the heating unit 50 to the contents of fluid reservoir 44.

The main components of the heating unit 50 according to one embodiment are best seen in FIG. 4. The heating unit 50 includes a reaction chamber 52. The reaction chamber 52 comprises a first reactant compartment 54 for holding a first reactant, a second reactant compartment 56 for holding a second reactant, a breakable barrier 58 separating the first and second reactant compartments, and a user interface 60 accessible by a user. The user interface 60 may include at least one member 62 responsive to the user interface 60 and operative to puncture the breakable barrier 58.

The user interface 60 may be an actuator button formed of a sufficiently flexible material that will allow the user interface 60 to be easily moved inward when force is applied thereto. At least one member 62 is connected to the user interface 60 and it may be connected on a first side opposite the second side accessed by the user. The member 62 extends from the first side of the user interface 60 and further includes at least one sharp piercing point 64 formed on its end proximal to the breakable barrier 58. Other end configurations operative to pierce the breakable barrier 58 may also be used. In the embodiment shown in FIG. 4, two members 62 extend from the user interface 60, but the invention encompasses designs with fewer or greater members 62. In one embodiment, the at least one member 62 will be formed at a height such that it nearly touches the breakable barrier 58.

The operation of heating unit 50 may be understood with reference to the cross sectional view of FIG. 4. This figure illustrates fluid reservoir 44 having the heating unit 50 inserted therein. The first reactant compartment 54 is filled with a first chemical reactant which, in one embodiment of the invention, is a solid material. A second reactant compartment 56 is shown filled with a second chemical reactant which is a liquid material is this embodiment. To activate the heating unit 50, force is placed on the user interface 60 which causes the members 62 to engage and penetrate the breakable barrier 58. When the force is released from the user interface 60, it will flex back to its original position and first and second reactants will be allowed to mix through the puncture in the barrier 58. The mixing of reactants will begin an exothermic reaction that will heat the contents of fluid reservoir 44 to a desired temperature.

Examples of suitable self-heating containers with integral heating units are disclosed in U.S. Pat. Nos. 5,461,867 and 5,626,022, issued to Scudder et al and an example of a separately insertable module is disclosed in U.S. Pat. No. 6,134,894 to Searle, et al. Such containers typically include a heating unit that normally contains two chemical reactants that are stable when separated from one another, but when mixed in response to actuation of the heating unit by a user, produce an exothermic reaction (or, alternatively, an endothermic reaction) and thereby heat (or cool) the contents of the container. The heating unit usually has two chambers, each of which contains one of the chemical reactants, separated by a breakable barrier such as metal foil. Typically, one of the reactants is a liquid, and the other is in a powdered or granular solid form. Calcium oxide and water are examples of two reactants known to produce an exothermic reaction to heat the container contents.

According to one embodiment, the reactants comprise calcium oxide and water. Additionally, while pure water and calcium oxide are in many cases suitable reactants, it is well known to add different chemical agents to the water and/or calcium oxide in order to vary different parameters of the reaction process. All such modifications of the water and/or calcium oxide reactants are intended to come within the scope of the present invention.

Examples of other mechanisms for puncturing breakable barriers between reactants in self-contained heating units are disclosed at U.S. Pat. Nos. 6,986,345, 6,786,330, 6,338,252, 5,461,867, 4,989,729, 5,255,812 and are incorporated herein by reference.

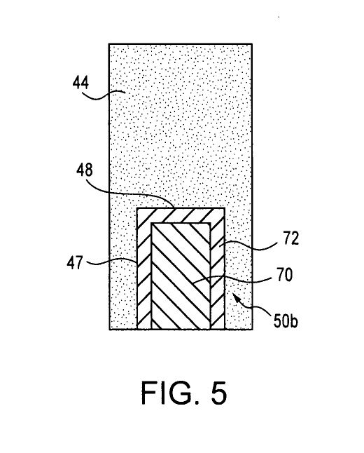

As depicted in FIG. 5, one skilled in the art will understand that, instead of utilizing a mixture of two reactants, the self-contained heating unit 50b may generate heat through the use of a battery 70 and heating element 72. In this embodiment, the self-contained heating unit 50b is activated by flowing current through the heating element 72. Other self-contained heating units may also be used.

In another embodiment according to the present invention, the cleaning implement 5 may contain multiple separate fluid reservoirs 44 wherein each fluid reservoir 44 contains its own heating unit 50. Alternatively, one fluid reservoir 44 having multiple cavities 45 to receive multiple heating units 50 may also be provided to heat the fluid reservoir 44.

Other cleaning implements may also be designed to be within the scope of the present invention. For example, the cleaning implement according to one embodiment may be a heated sponge. In this embodiment, the heating unit may be a removable tube shaped unit that is disposed within the sponge body. In this embodiment, the fluid reservoir may be a separate container or may be the sponge itself and associated pores.

The cleaning implement may also be a glove shaped cleaning device that may be used to wash a vehicle. In this embodiment, the heating unit is disposed within the glove and may heat both cleaning fluid and the user's hand.

The cleaning implement may also be a heated squeegee-like device that may be used to assist in scraping ice or insects from a vehicle window. The heating unit may warm a fluid reservoir to provide heated cleaning fluid. The heating unit may heat the tip of the squeegee-like device through conduction to further assist in scraping ice.

The cleaning implement may also be a wall cleaner used to remove marks from a wall. The wall cleaner may have a dense cleaning pad that contains a heated fluid reservoir to apply heated fluid to a wall.

The cleaning implement may also be a soft brush having a heated fluid reservoir that may be used to assist in gently removing insects from a vehicle.

It is therefore intended that the foregoing detailed description be regarded as illustrative rather than limiting, and that it be understood that it is the following claims, including all equivalents, that are intended to define the spirit and scope of this invention.

1. A motorless cleaning device comprising:
a handle having a first end and a second end;
a cleaning surface section proximal to the second end and engageable with a surface to be cleaned;
a cleaning fluid container connectable to the handle and defining a chamber for holding a volume of cleaning fluid,
a fluid delivery nozzle in fluid communication with the cleaning fluid container for distributing cleaning fluid to the surface to be cleaned; and
a heating unit in thermal contact with the cleaning fluid container and operable to increase the temperature of the cleaning fluid within the cleaning fluid container.

2. The cleaning device of claim 1 wherein the heating unit comprises a first reactant chamber having a first reactant and a second reactant chamber having a second reactant, wherein mixing of the first reactant and the second reactant creates heat and warms the cleaning fluid.

3. The cleaning device of claim 1 wherein the heating unit comprises a battery and heating element.

4. The cleaning device of claim 1 wherein the cleaning surface section comprises a member having a substantially flat lower surface

5. The cleaning device of claim 4 wherein the cleaning surface section further comprises a detachable cleaning fabric engageable with the substantially flat lower surface of the cleaning surface section.

6. The cleaning device of claim 4 wherein the cleaning surface section further comprises an upper surface with the fluid delivery nozzle being connected to an upper surface of the cleaning surface section.

7. The cleaning device of claim 1 wherein the heating unit is disposed within a cavity defined by the cleaning fluid container.

8. The cleaning device of claim 7 wherein the heating unit is removably disposed within the cavity of the cleaning fluid container.

9. The cleaning device of claim 1 wherein the fluid container comprises a holder connectable to the handle and a fluid reservoir containing a volume of cleaning fluid, and wherein the fluid reservoir is removably disposed within a cavity defined by the holder.

10. A method of cleaning a surface using heated cleaning fluid, the method comprising the steps of:
providing a motorless heated cleaning fluid assembly comprising a cleaning fluid container for holding a volume of cleaning fluid, a heating unit in thermal contact with the cleaning fluid container, and a cleaning surface section connected with the cleaning fluid container;
activating the heating unit to generate heat;
warming the cleaning fluid within the cleaning fluid container with heat generated by the heating unit; and
applying the warmed cleaning fluid to the surface to be cleaned such that the surface to be cleaned is wetted with cleaning fluid.

11. The heated cleaning fluid assembly of the method of claim 10 further comprising a fluid delivery nozzle in fluid communication with the cleaning fluid container for applying cleaning fluid to the surface to be cleaned

12. A cleaning fluid heating system comprising:
a cleaning fluid reservoir for containing a volume of cleaning fluid;
a self contained heating unit in thermal contact with the cleaning fluid reservoir wherein heat generated by the self-contained heating unit warms the volume of cleaning fluid within the cleaning fluid reservoir.

13. The cleaning fluid heating system of claim 12 wherein the self-contained heating unit is disposed within a cavity defined by the cleaning fluid reservoir.

14. The cleaning fluid heating system of claim 12 wherein the self-contained heating unit comprises reactants operative to generate heat when combined.

15. The cleaning fluid heating system of claim 14 wherein the self-contained heating unit comprises a first reactant chamber having a first reactant and a second reactant chamber having a second reactant wherein mixing of the first reactant and the second reactant generates heat and warms the cleaning fluid.

16. The cleaning fluid heating system of claim 15 wherein the self-contained heating unit further comprises a breakable barrier between the first reactant chamber and the second reactant chamber and comprises a trigger operative to pierce the breakable barrier when a force is applied to the trigger.

17. The cleaning fluid heating system of claim 12 wherein the self-contained heating unit comprises a battery and a heating element.
